(19) United States
(12) Patent Application Publication
(10) Pub. No.: US 2015/0329262 A1
(43) Pub. Date: Nov. 19, 2015

(54) Container with Reusable Vacuum Seal Lid

(71) Applicant: Robert E. Barbour, JR., Fort Worth, TX (US)

(72) Inventor: Robert E. Barbour, JR., Fort Worth, TX (US)

(21) Appl. No.: 14/280,346

(22) Filed: May 16, 2014

(51) Int. Cl. B65D 81/20; B65B 31/04; A61J 1/00; B65D 39/00; B65D 51/16

(52) U.S. Cl. CPC B65D 81/2038; B65D 39/0005; B65D 51/1644; A61J 1/00; B65B 31/046

(57) ABSTRACT

A method of vacuum sealing a container by drawing a vacuum at the external end of a one way valve configured to automatically close upon a vacuum being achieved in the container. The one way valve utilizing a spherical stopper which randomly reorients at each use to prevent wear incapacitating the valve after repeated uses.

### NOTICE OF INTENT TO RESERVE COPYRIGHT OR MASK WORK RIGHTS

Not Applicable.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

It has long been understood that air has a degenerative effect on medications. Moisture in the air can cause coatings to dissolve, and create a chemical instability of the medications. Crystalline substances such as vitamin C and some forms of vitamin B are prone to deliquescence. Oxygen in the air can oxidize chemicals or cause fat soluble vitamins, like A, D, E, and K to go rancid. These degradations cause issues which may be cosmetic, such as unsightly spotting and undesirable taste, or more serious problems with loss of potency or ineffectiveness.

In addition to moisture, air also contains bacteria, viruses, and mold spores. The degradation of medications is further aggravated by the higher humidity areas of the kitchen and bathroom of typical home settings where most medicines are stored. These locations are also where bacteria, virus, and mold are in heaviest concentrations.

Different crystalline substances deliquesce at different humidity levels. For example, at room temperature, sodium ascorbate would deliquesce at 86 percent humidity, ascorbic acid (vitamin C) at 98 percent humidity and fructose at 62 percent. Some ingredient blends deliquesce in as low as 30 percent humidity. Once humidity is reduced, products can resolidify, but chemical changes or degradation that has already occurred do not reverse upon resolidification.

Knowing of these problems, manufacturers vacuum seal bottles or displace air with quantities of inert gasses to improve shelf life. However, once opened in the home, the process begins with the opening, and continues as long as moisture is present. Air trapped in the bottle will continue the degradation process even after the bottle is resealed. Every opening and closing of the package will change the atmosphere inside the package and restart the degradation process.

While different atmospheric gases may be an issue, water vapor/moisture is one of the biggest issues. Therefore, it is desirable to remove moisture from the container upon resealing. One means of doing this is to include desiccant in the bottles, as described in Chinese Patent CN 202802151 by [symbol] entitled “Medicine bottle filled with solid silica tablet desiccant.”Desiccant removes moisture from the air, but takes time to achieve this action. So, while desiccant reduces the issue, it does not eliminate it.

Another method of preserving medication is to remove the atmospheric gases, including any water vapor, by creating a vacuum in the container after resealing. Previous vacuum bottles utilized needles passed through permeable membranes. These permeable membranes can degrade over multiple uses. Depending on how they are utilized, they may also leak or slip from proper placement.

An example is described in Chinese Publication CN 203060300 U by [symbol] entitled “Vacuum Medicine Bottle used for holding tablets.” This method require syringes to draw the air through one way valves. These one way valves can leak, as they require a cylindrical plug to continually reseat. The plug degrades over repetitive usage and/or deforms, allowing leaks of air back into the container over a period of time.

Another method of prolonging product life is to vacuum seal individual servings/dosages. This alternative requires packaging to be in the smallest possible dosage/serving so multiples can be used when more is needed. This is a more costly alternative and leads to excessive waste of packaging material and storage space. Foil packets are also difficult for some people to open.

Although a few recent improvements have appeared in the industry, the primary methods of preserving medicine dates back to the nineteenth century with only small adjustments having been made in the bottle colors and the introduction of child proof caps. The basic method currently remains to place a piece of cotton in a bottle and re-cap after each use. This method is often defeated by the mistaken belief that the cotton's purpose is to protect against damage during shipping, causing many people to discard said cotton upon initial opening along with other packaging.

### BRIEF DESCRIPTION OF THE DRAWINGS

FIG. 1 illustrates a perspective view of a vacuum seal container in accordance with an exemplary embodiment of the invention.

FIG. 1A shows a cross section of the container lid from FIG. 1.

FIG. 2 illustrates a perspective of a vacuum seal container with manual pump cap in accordance with an exemplary embodiment of the invention.

FIG. 2A shows a cross section of the container lid with manual pump cap from FIG. 2.

FIG. 3A illustrates a side view of vacuum seal container with optional manual pump cap in accordance with an exemplary embodiment of the invention. The cap is shown in the closed position.

FIG. 3B illustrates a side view of vacuum seal container with optional manual pump cap in accordance with an exemplary embodiment of the invention. The cap is shown in an open position.

FIG. 4 illustrates a vacuum seal container sealing via suction bulb in accordance with an exemplary embodiment of the invention.

FIG. 5 illustrates a vacuum seal container sealing via hand pump in accordance with an exemplary embodiment of the invention.

FIG. 6 illustrates a vacuum seal container sealing via electric pump in accordance with an exemplary embodiment of the invention.

### DETAILED DESCRIPTION OF THE PREFERRED EMBODIMENTS

Removing air from a bottle preserves potency of medicine so that it will remain at maximum effectiveness until expiration. Described herein is a storage container cap with aggregated vacuuming mechanism for use on storage containers. The vacuuming mechanism is utilized to remove atmospheric air from the container once the cap has been replaced. In one embodiment, the act of pushing the cap down onto the bottle decompresses a domed bulb at the same time causing the vacuum to automatically be created in the bottle through the normal act of closing said bottle. For purposes of this description, a vacuum refers to any pressure lower than atmospheric pressure caused by the reduction of air in a given location.

The innovation comprises the use of a spherical stopper in a conic valve body incorporated into one surface of the container. This surface in the preferred embodiment is the replaceable removable top of the container. The conic valve body intrudes from the surface of the container and narrows at the distal end. An optional retainer ring above the spherical stopper prevents it from being removed from the conic valve.

Air is drawn from the container's interior through the conic valve, dislodging the spherical stopper in the process. Once the draw is completed, the internal vacuum pulls the spherical stopper back to the narrow end of the valve, completing the seal. The spherical shape of the stopper prevents a repetitive wear of the stopper as it randomly reorients with each use.

In the preferred embodiment, a split washer seats in a groove of the interior wall of the valve above the spherical stopper. This washer prevents the spherical stopper from exiting the valve body with the drawn air. The split configuration of the washer prevents the spherical stopper from forming a secondary seal against the washer, preventing the drawn air from exiting the container. One skilled in the arts would appreciate that washers could contain voids or the walls of the valve could contain grooves. Additionally, the valve could be replaced by a screen or other construction that allows air to pass through the valve without allowing the spherical stopper to exit the valve body, while still allowing the spherical stopper to freely reorient between seatings.

In one embodiment the valve is open to the environment on the outside of the container, and may or may not protrude outside of the container. Being open to the environment allow the drawing of air to be accomplished by use of suction bulbs, hand pumps, and/or electric pumps. This configuration is very useful for factory filling or in pharmacies where multiple containers are repetitively filled. However, they are less convenient for the average consumer who would have to have a separate device for creating the suction to draw air from the container. Additionally, this method may allow the top of the valve to collect moisture or dust which may fall into the container when the spherical stopper repositions due to breaking of the vacuum seal.

In another configuration, the wider portion of the valve extends outward from the surface of the container forming an edge or lip onto which a secondary cover can be secured. The secondary cover further secures the vacuum seal against possible movement of the spherical stopper due to impact/jarring of the container. Additionally, the secondary cover prevents moisture or dust or other contaminants from collecting on the exposed surface of the spherical stopper.

The secondary cover may be temporary such that the original opening may still be utilized as a connection point for drawing suction through the valve. In one embodiment, the secondary cover may be substantially permanent such that the original opening is not directly accessible.

In another embodiment, the substantially permanent secondary cover may incorporate another opening through which a vacuum may be drawn. In these configurations, the spherical stopper is not relied on to fully ensure the internal vacuum is maintained. A secondary environment is maintained between the spherical stopper of the one way valve and the secondary cover. This secondary environment may also be a vacuum, or a partial vacuum.

In one embodiment, the method for drawing a vacuum from the container is incorporated into the design as a secondary chamber which can be deformed, where the chamber's tendency to return to its original shape produces a pumping action by drawing a vacuum to remove air from the container's chamber, the primary chamber.

In the preferred embodiment, a domed bulb of semi-rigid material is sealed to the container surface creating a sealed chamber, the secondary chamber. The secondary chamber encompasses the protruding end of the one way valve, thus creating a primary opening in the secondary chamber, and linking the two chambers together selectively by the one way valve. The domed bulb further comprises a secondary opening to the external environment, which the semi-rigid nature of the material biases to a closed position.

In the preferred embodiment, this is a small cut in the bulb material. In the preferred embodiment, the cut is surrounded by a slightly raised ring creating a thicker material surrounding the cut and preventing the enlarging of the opening. One skilled in the arts would appreciate that other configurations may be utilized to produce the same effect of a secondary opening which is selectively closed or opened in varying conditions.

In the preferred embodiment, the second opening has a significantly smaller volume than the first opening. Collapsing the dome increases the pressure in the bulb by lowering the volume of the bulb. The increased pressure forces air from the two openings of the secondary chamber. However, the pressure differential between the secondary chamber and the primary chamber urges the spherical stopper toward the narrower end of the conic valve body (a closed position), preventing air from entering the container's primary chamber. Thus, the substantial majority of the air will exit the second opening into the surrounding environment.

Once the pressure collapsing the dome is removed, the semi-rigid material biases the dome back to its relaxed state, lowering the pressure in the secondary chamber and closing the secondary opening. This lower pressure in the secondary chamber causes the higher pressure of the primary chamber to urge the spherical stopper toward the wider end of the conic valve body (an open position). With the valve in the open position, air will exit the primary chamber to equalize the pressure between the two chambers. Repeating the process will continue to lower the pressure in the primary chamber until a vacuum is induced in the primary chamber, at which point any further attempts will simply move air in and out of the secondary chamber without effect on the primary chamber.

One skilled in the arts would appreciate that the methods described herein are applicable to food storage, particularly spices, sugars, salts, and other long term use, humidity sensitive items. Further, the containers can be of various shapes and sizes. The innovations described herein for producing a vacuum in a medicine bottle are equally applicable to larger containers. Similar apparatuses, properly scaled, can be utilized to protect bulk quantities stored in buckets or drums.

In a different implementation of the same teachings, placing the one way valve on the lower end of the container rather than the top of the container would allow it to be used to remove liquids from contents of sufficiently large size as to prevent them from congesting the smaller intake end of the valve's conic body.

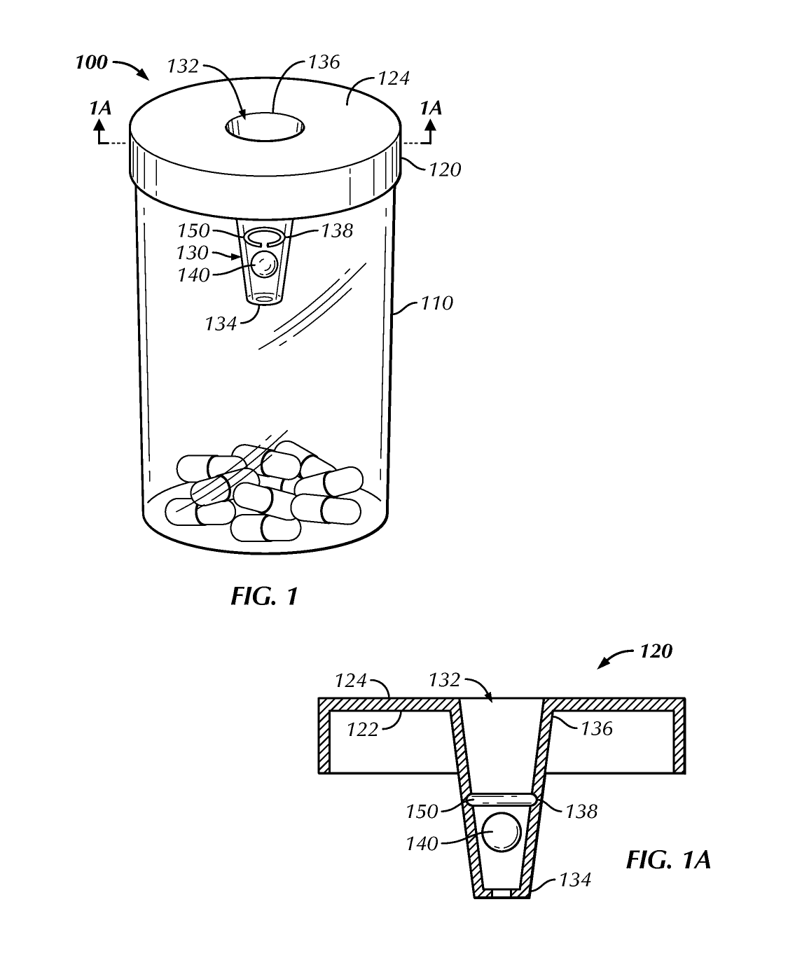

FIG. 1 illustrates a perspective view of a vacuum seal container in accordance with an exemplary embodiment of the invention. The vacuum seal container (100) comprises a base (110) and a lid, cap, or cover (120) which removeably mate to form an air-tight seal.

One surface, the cover (120), further comprises a one-way vacuum valve (130) which has a conic body (132) which opens from a wide end (136) on the outside surface (124) of the cover (120), passing through the cover (120) and extending from the inside surface (122) of the cover (120) into the container (100).

The conic body (132) houses a spherical stopper (140) which is larger than the opening at the narrow end (134) of the conic body (132) of the one-way valve (130). Inside the conical body (132) there is a retainer groove (138) into which a retainer ring (150) seats thus retaining the spherical stopper (140) between the retainer ring (150) and the narrow end (134) of the conic body (132).

FIG. 1A shows a cross section of the container lid from FIG. 1. The cover (120) has a conic body (132) which extends from a wider end (136) starting at least at the outside surface (124) and extending through the cover (120) to protrude substantially perpendicularly from the inside surface (122).

The conic body (132) accommodates a spherical stopper (140) contained in between a retaining ring (150), seated in a retainer groove (138), and the narrower end (134). The spherical stopper (140) will seal against the round cross section of the inside of the conical body (132) to form an air-tight seal when urged toward the narrow end (134).

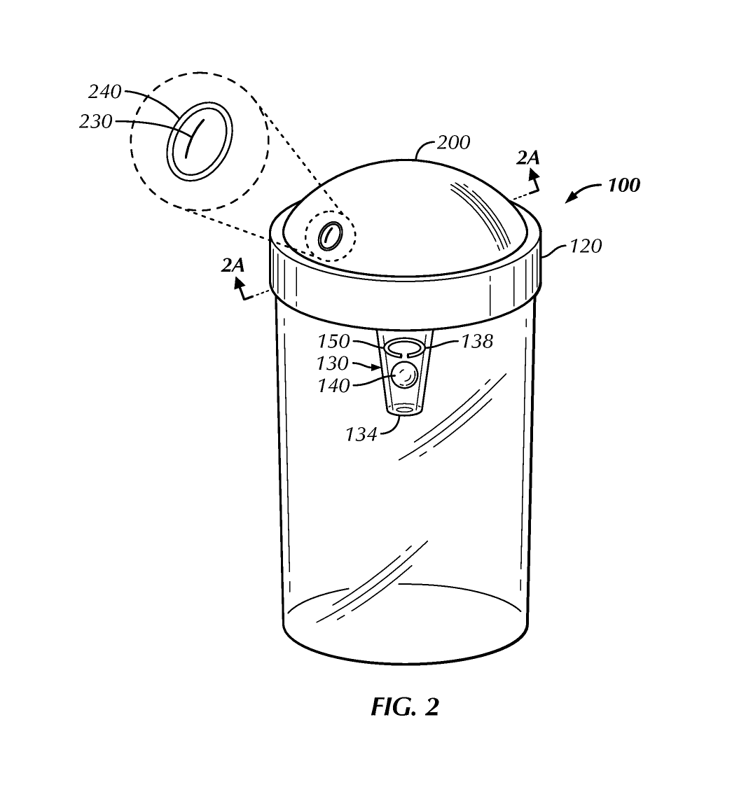

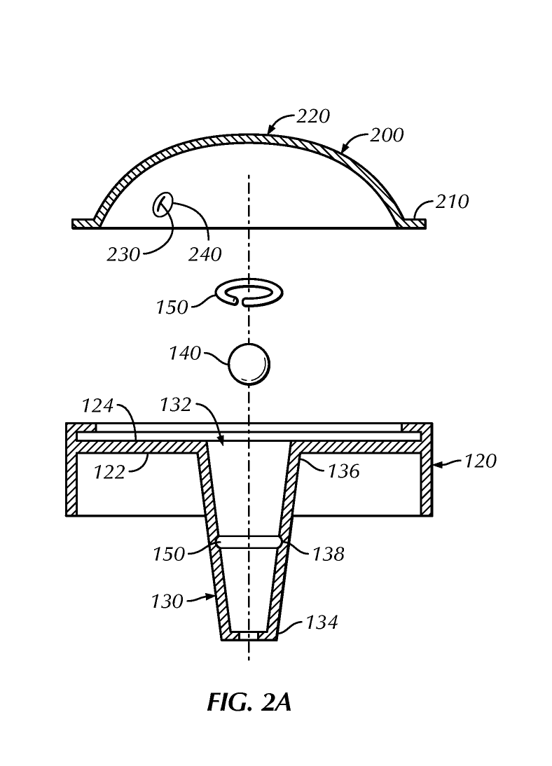

FIG. 2 illustrates a perspective of a vacuum seal container with manual pump cap in accordance with an exemplary embodiment of the invention. The lid (120) of the container (100) further comprises an extractor pump (200) formed from a semi-rigid material sealed to the outside surface (124) of the lid (120) and encompassing the wide end (136—not visible) of the vacuum valve (130—not labeled). The extractor pump (200) has a secondary opening (230) in the form of a small cut through the material, and surrounded by a raised right (240) which prevents unintentional enlargement of the cut via a tearing of the material. As indicated in previous figures, the retaining ring (150) seats in the retainer groove (138) retaining the spherical stopper (140) in the narrow end (134) of the conic body (132—not labeled) of the vacuum valve (130).

FIG. 2A shows a cross section of the container lid with manual pump cap from FIG. 2. In this embodiment, the edge of the lid (120) extends to form a pocket into which the sealing edge (210) of the extractor pump's (200) domed bulb (220) can be affixed against the outside surface (124) of the lid (120) to create a secondary chamber comprised of the domed bulb (220) and the lid (120).

The extractor pump (200) operates by deforming the domed bulb (220) to increase air pressure on the spherical stopper (140) urging it down the conic body (132) of the vacuum valve (132) toward the narrow end (134) (the closed position), causing a sealing action. Air is then forced to exit through the secondary opening (230), resulting in a lower volume of air in the secondary chamber.

As the domed bulb (220) is released and returns to its original shape, air enters the narrow end (134) of the vacuum valve (130) to compensate for the lower volume of air in the secondary chamber. This air urges the spherical stopper (140) toward the wide end (136) (the open position) where it comes in contact with the retainer ring (150) seated in the retainer groove (138). Once a vacuum is achieved in the container, the spherical stopper (140) returns to its closed position.

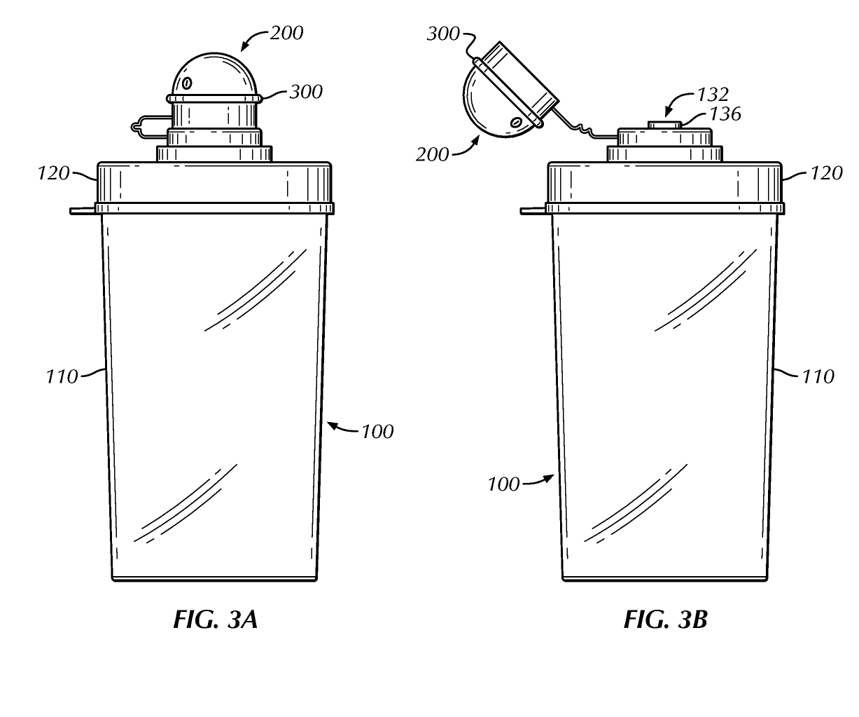

FIG. 3A and 3B illustrate side views of a vacuum seal container with optional manual pump cap in accordance with an exemplary embodiment of the invention. Turning to FIG. 3A, the cap is shown in the closed position. The container's (100) lid (120) has a vacuum valve (130—now shown) which is encompassed under a vacuum valve cover (300). The vacuum valve cover (300) further comprises an extractor pump (200) which can be utilized in the manner previously described to create a vacuum in the container base (110).

In FIG. 3B the cap is shown in the open position. In this position, the wide end (136) of the conic body (132) is accessible to draw a vacuum utilizing means other than the manual extractor pump (200) incorporated in the vacuum valve cover (300).

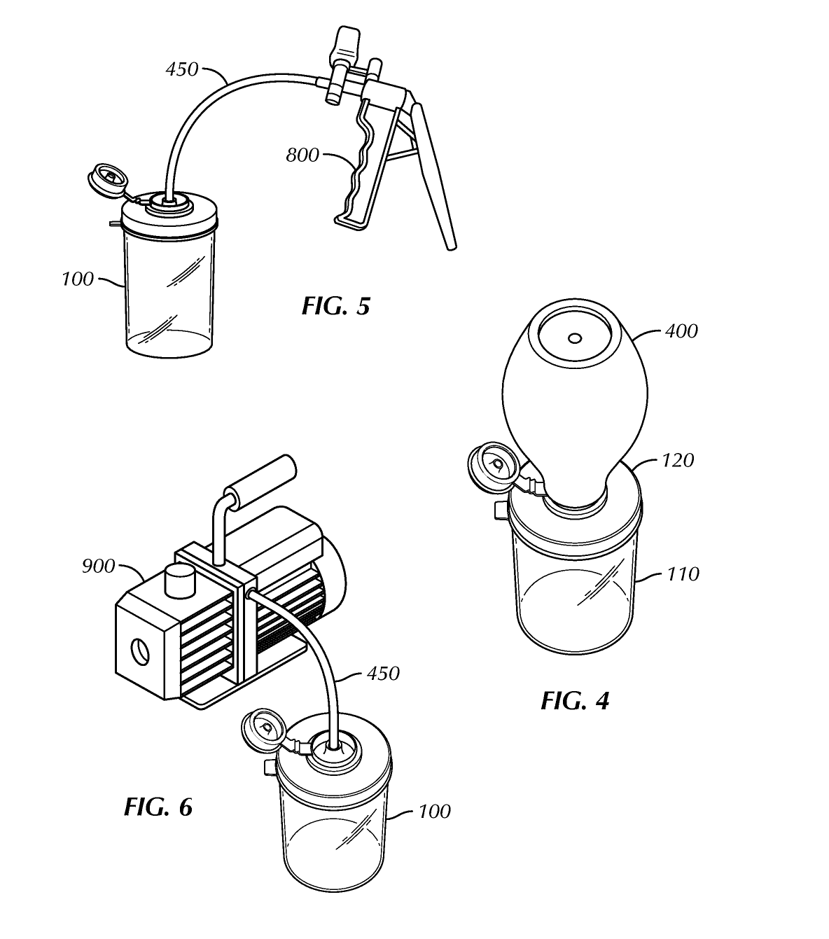

FIG. 4 illustrates a vacuum seal container sealing via suction bulb in accordance with an exemplary embodiment of the invention. The suction bulb (400) can be held to the lid (120) to generate a vacuum in the container base (110). A single suction bulb (400) can be utilized with multiple containers to produce a lower cost option where each container does not need to incorporate an extractor pump (200—previous figures).

FIG. 5 illustrates vacuum seal container sealing via hand pump in accordance with an exemplary embodiment of the invention. A hand pump (800) is attached to a container (100) via a flexible hose (450) to allow repetitive use in environments where there may be multiple containers (100). This method may be useful for hospitals, care facilities, etc., where large numbers of containers may be opened and resealed at standard dosing times.

FIG. 6 illustrates a vacuum seal container sealing via electric pump in accordance with an exemplary embodiment of the invention. An electric pump (900) is attached to a container (100) via a flexible hose (450) to allow repetitive use in environments where there may be multiple containers (100). This method may be useful for factories or pharmacies where initial filling of extremely large numbers of containers may be sealed. Manifolds would allow sealing of multiple containers simultaneously.

The diagrams in accordance with exemplary embodiments of the present invention are provided as examples and should not be construed to limit other embodiments within the scope of the invention. For instance, heights, widths, and thicknesses may not be to scale and should not be construed to limit the invention to the particular proportions illustrated. Additionally, some elements illustrated in the singularity may actually be implemented in a plurality. Further, some elements illustrated in the plurality could actually vary in count. Further, some elements illustrated in one form could actually vary in detail. Further yet, specific numerical data values (such as specific quantities, numbers, categories, etc.) or other specific information should be interpreted as illustrative for discussing exemplary embodiments. Such specific information is not provided to limit the invention.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A vacuum sealing container comprising;
a primary chamber;
a one-way valve extending from the primary chamber;
wherein the valve comprises:
a tapered internal cavity; and
a repositionable spherical stopper.

2. A vacuum sealing container, as described in claim 1 wherein the wider end of the taper projects from the outer surface of the container.

3. A vacuum sealing container, as described in claim 1 further comprising a retainer positioned between the wider end of the tapered cavity and the stopper preventing the stopper from exiting the wider end of the tapered cavity.

4. A vacuum sealing container, as described in claim 1 further comprising a cover for sealing the wider end of the taper after a vacuum is drawn in the primary chamber.

5. A vacuum sealing container, as described in claim 4 wherein the cover further comprises:
a secondary chamber encompassing the wider end of the valve, wherein a vacuum in the secondary chamber draws air from the primary chamber through the valve.

6. A method of vacuum sealing a container comprising:
having a first chamber comprising, at least, a base and a removable lid;
having a one-way valve extending through the lid allowing passage from the inside of the first chamber to the outside;
the one-way valve comprising:
a tapered inner passage, the narrow end opening inside of the first chamber, and the wider end opening outside of the first chamber;
a spherical stopper capable of sealing against the inner walls of the passage to create an air tight seal;
drawing a vacuum at the wider end, causing air to dislodge the stopper and exit the first chamber creating a vacuum in the first chamber;
ceasing to draw a vacuum at the wider end, allowing the lower pressure of the first chamber to lodge the stopper in the tapered passage, thus sealing the passage.

7. A method of vacuum sealing a container, as described in claim 6 further comprising:
sealing the wider end of the tapered passage after drawing a vacuum in the primary chamber to further secure the vacuum.

8. A method of vacuum sealing a container, as described in claim 6 wherein drawing a vacuum at the wider end is accomplished via a suction bulb.

9. A method of vacuum sealing a container, as described in claim 6 wherein drawing a vacuum at the wider end is accomplished via a hand pump.

10. A method of vacuum sealing a container, as described in claim 6 wherein drawing a vacuum at the wider end is accomplished via an electronic pump.

11. A method of vacuum sealing a container, as described in claim 10 wherein an electronic pump is connected via a manifold to a plurality of other containers simultaneously.

12. A method of vacuum sealing a container, as described in claim 6 wherein drawing a vacuum at the wider end further comprises:
having a cover on the wider end;
the cover comprising:
a secondary chamber; and
a secondary opening, normally closed, and automatically opened upon increased pressure;
deforming the secondary chamber to increase the pressure;
the increased pressure of the secondary chamber causing the closing of the valve connected to the first chamber, and expelling air from the secondary opening;
releasing the secondary chamber;
allowing the secondary chamber to return to normal volume, thus causing a vacuum in the secondary chamber;
the decreased pressure of the secondary chamber causing the opening of the valve connected to the first chamber, and then drawing a vacuum in the first chamber.
